(19) United States
(12) Patent Application Publication
(10) Pub. No.: US 2003/0076568 A1
(43) Pub. Date: Apr. 24, 2003

(54) Light frequency stabilizer

(75) Inventors: Pingfan P. Wu, Willingboro, NJ (US); Liang-Ju Lu, Eden Prairie, MN (US)

Correspondence Address: ALTERA LAW GROUP, LLC, 6500 CITY WEST PARKWAY, SUITE 100, MINNEAPOLIS, MN, 55344-7704, US

(73) Assignee: ADC Telecommunications, Inc., Eden Prairie, MN

(21) Appl. No.: 10/014,218

(22) Filed: Oct. 22, 2001

(51) Int. Cl. H04J 14/02; H04B 10/04

(52) U.S. Cl. 359/187; 359/133

(57) ABSTRACT

An improved optical frequency stabilization unit utilizes the frequency-dependent phase retardation of a birefringent element as a frequency reference. A light frequency stabilization unit includes a birefringent element having a longitudinal axis, the optic axis of the birefringent element is oriented to retard the phase of polarized light propagating through the element parallel to the longitudinal axis. The phase is retarded by an amount that is proportional to the frequency of the polarized light. A polarizer transmits a portion of the phase-retarded light. The magnitude of the transmitted portion is determined by the phase retardation amount. A first optical detector is disposed to detect the transmitted portion of light and to generate a first signal in response to the transmitted portion detected.

### FIELD OF THE INVENTION

The present invention is directed generally to devices for the frequency-stabilization of light sources, and more particularly to the frequency-stabilization of semiconductor lasers.

### BACKGROUND

Frequency-stabilized light sources are required for a wide range of applications including optical fiber communications, fiber optic sensing, metrology and atmospheric remote sensing. In an exemplary optical communications application, for example, large amounts of information may be transferred through an optical transport system by combining a plurality of narrow-band channels into a multi-channel wideband optical signal. A single-channel information signal may be generated, for example, by externally-modulating the output of a single-frequency laser. Multiple channels at different frequencies are typically combined by one or more wavelength multiplexers into a dense wavelength division multiplexed (DWDM) signal that may be transported to an optical receiving station by a single optical fiber. At the receiver, the DWDM signal is separated into the component, single-channel optical signals before detection.

The International Telecommunications Union (ITU) has set DWDM standards that specify the operating wavelengths for the individual channels of a DWDM signal. According to these standards, the separation between adjacent channels is typically a fixed frequency. For example, the inter-channel spacing may be 100 GHz or 50 GHz.

In order to minimize interchannel crosstalk and other types of distortion, the single-mode semiconductor laser transmitters in a DWDM system are stabilized to a small fraction of the inter-channel spacing, typically to within a width of 3 GHz. Semiconductor laser output wavelengths typically drift over their operating lifetimes and may be affected by temperature and variations in drive current. Active frequency stabilization units are, therefore, typically incorporated into optical communications transmitters.

Frequency stabilization systems conventionally include interferometers, gratings and/or spike filters. For example, a frequency error signal is often generated by measuring the transmission of two Fabry Perot etalons with different frequency-dependent transmission functions. In order to provide an absolute frequency reference, the lengths of the etalons are stabilized to a small fraction of a wavelength and the alignment of each etalon with respect the input beams must be held within tight tolerances over long periods of time. The stabilization of etalon length and alignment are typically accomplished through a combination of careful optomechanical design, thermal isolation and/or electronic stabilization. As a result, Fabry-Perot etalon assemblies, like many other conventional optical frequency references are optomechanically complex and expensive.

### SUMMARY OF THE INVENTION

Generally, the present invention relates to a device for the frequency-stabilization of a light source, typically a laser light source. Conventional frequency stabilization units typically incorporate interferometric references that are stabilized against environmental noise. These assemblies are complex, expensive and difficult to manufacture. According to the present invention, an improved optical frequency stabilization unit utilizes the frequency-dependent phase retardation of a birefringent element as a frequency reference, thereby providing improved immunity to vibration, alignment and temperature fluctuations.

One particular embodiment of the invention is directed to a light frequency stabilization unit that includes a birefringent element having a longitudinal axis. The birefringent element has an optical axis oriented to retard phase of polarized light propagating through the element substantially parallel to the longitudinal axis. The phase is retarded by an amount proportional to a frequency of the polarized light. A polarizer receives phase-retarded light from the birefringent element, and transmits a portion of the phase-retarded light. The magnitude of the transmitted portion is determined by the phase retardation amount. A first optical detector detects the transmitted portion of light and generates a first signal in response to the transmitted portion detected. An electronic error circuit is coupled to the detector to generate a frequency stabilization signal in response to the first signal.

Another embodiment of the invention is directed to a frequency-stabilized laser source that includes a laser with a frequency-control port, an operating frequency of the laser being variable in response to a frequency control signal applied to the frequency control port. The birefringent element has an optical axis oriented to retard phase of polarized light propagating through the element substantially parallel to the longitudinal axis. The phase is retarded by an amount proportional to a frequency of the polarized light. A polarizer receives phase-retarded light from the birefringent element, and transmits a portion of the phase-retarded light. The magnitude of the transmitted portion is determined by the phase retardation amount. A first optical detector detects the transmitted portion of light and generates a first signal in response to the transmitted portion detected. A feedback circuit receives the first signal and provides the frequency control signal to the laser frequency control port.

Another embodiment of the invention is directed to an optical communications system that includes a transmitting unit including a light frequency stabilization unit disposed to stabilize frequency of at least one optical signal. The frequency stabilization unit includes a birefringent element having a longitudinal axis, the optic axis of the birefringent element oriented to retard phase of input polarized light propagating through the element substantially parallel to the longitudinal axis by a phase retardation amount that is proportional to the frequency of the polarized light over a range of frequencies. A polarizer receives phase-retarded light from the birefringent element and transmits a portion of the phase-retarded light, a magnitude of the transmitted portion being determined by the phase retardation amount. A first optical detector detects the transmitted portion of light and generates a first signal in response to the transmitted portion detected. An electronic error circuit generates a frequency stabilization signal in response to the first signal. The system also includes a receiving unit and an optical transport system coupled to carry optical signals from the transmitting unit to the receiving unit.

Another embodiment of the invention is directed to a method for generating a light frequency stabilization signal. The method includes retarding polarized light using a birefringent element by an amount that is proportional to the frequency of the polarized light, and analyzing the phase-retarded light with a polarization analyzer to produce an analyzed light beam. The method also includes measuring power of the analyzed light beam with a first detector to generate a first signal indicative of light frequency and generating the light frequency stabilization signal in response to the first signal.

Another embodiment of the invention is directed to a method for stabilizing the frequency of a laser. The method includes retarding phase of polarized light generated by the laser by an amount that is proportional to a light frequency and analyzing the phase-retarded light with a polarizer to produce an analyzed light beam. The method also includes measuring power of the analyzed light beam with a first detector to generate a first signal indicative of laser frequency, generating a laser feedback signal in response to the first signal, and adjusting frequency of the laser according to the feedback signal so as to stabilize the frequency of the laser.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a dense wavelength multiplexed communications system;

FIG. 2 schematically illustrates a laser transmitter incorporating a light frequency stabilizer;

FIG. 3 schematically illustrates a conventional Fabry-Perot light frequency stabilizer;

FIG. 4 schematically illustrates a birefringent light frequency stabilizer according to an embodiment of the present invention;

FIG. 5 graphs the frequency dependence of the light power received by the detector in a birefringent light frequency stabilizer that includes a birefringent element having a birefringence that is approximately constant with respect to frequency;

FIG. 6 is a graph of detector power showing optimal locking frequencies according to an embodiment of the present invention;

FIG. 7 schematically illustrates a tunable, temperature-compensated birefringent element assembled from two birefringent pieces; and

FIG. 8 schematically illustrates a power-corrected birefringent light frequency stabilizer according to an embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to the frequency stabilization of polarized light sources, and is believed to be particularly suited to the stabilization of single-mode laser light sources.

A laser source typically oscillates in at least one longitudinal mode and one at least one transverse mode that determine the output frequencies of the laser. The relationship between laser output frequency and mode structure is well known, for example as is described in Lasers by A. E. Seigman (University Science Books, Sausalito, 1986) and in Tunable Laser Diodes by Markus-Christian Amann and Jens Buus (Artech House, Boston, 1998). Lasers that emit light in a single, narrow band of frequencies are referred to as single-frequency lasers. Single-frequency lasers typically oscillate in a single longitudinal mode and a single transverse mode.

The instantaneous linewidth of a single-frequency diode laser is typically less than 10 MHz. Over time intervals of a second or more, however, the oscillating frequency may drift over a much wider range of frequencies. This drift may be caused by fluctuations in junction current and/or temperature in addition to device aging effects. For example, the distributed feedback diode lasers, commonly used for telecommunications applications at wavelengths near 1.55 μm, may tune with junction current at a rates of approximately 100 GHz/mA.

In terrestrial fiber optic communications networks, the International Telecommunications Union (ITU) has set standards for the operating wavelengths of the channels in a DWDM system. According to these standards, individual wavelengths are separated by a fixed frequency difference that may be, for example, equal to 50 GHz or 100 GHz. Current variations as small as 1 mA may, therefore, move the frequency of a diode laser transmitter from one channel to another. Small changes in junction temperature and aging effects may also change the frequency of the light emitted from the laser.

Active frequency control may be used to oppose diode laser frequency drift. For example, frequency control may be used to lock the operating frequency of a laser to a channel of the ITU grid. A laser frequency stabilizer may also be required for other applications including fiber optic sensors, remote gas sensors, metrology systems, and Doppler velocimeters.

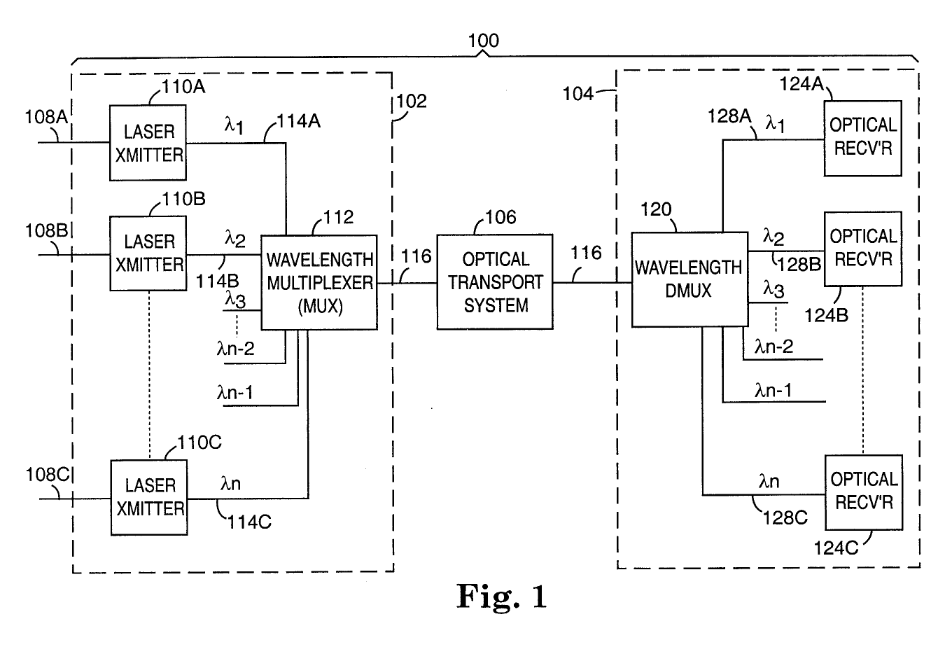

FIG. 1 is a schematic representation of a typical DWDM optical communication system 100 that is designed to transport a plurality of information signals from a transmitter unit 102 to a receiver unit 104. Signals are transported between the transmitter unit 102 and receiver unit 104 by an optical transport system 106. The optical transport system may, for example, be a guided wave system, a free space system or a hybrid system with both guide-wave and free space optical paths.

Input information signals may be carried to the transmitter unit 102 by conventional electronic cables 108A-108C. The input signals are then converted to optical signals by laser transmitters 110A-110C that modulate the amplitude, phase, or frequency of single-frequency light beams in response to the input signals. Three transmitters have been included in FIG. 1 for purposes of illustration, but it will be appreciated by those skilled in the art that DWDM systems may include a large number of laser transmitters.

The laser transmitters 110A-110C typically operate at output frequencies that are assigned according to an established standard (the ITU standard, for example). Thus, the input signal carried to the transmitter unit 102 by cable 108A may be converted to an optical signal having with a light frequency, f₀, by the laser transmitter 110A. The laser transmitter 110A typically includes a single-frequency semiconductor laser that is modulated directly or externally modulated, for example, with an electro-optic modulator according to the input signal. Other inputs 108B and 108C are similarly converted to optical signals with different frequencies, f₂ and f₂ₘ by the laser transmitters 110B and 110C. In systems that assign channel frequencies according to the ITU standard, the separation between adjacent channel frequencies is a constant.

Optical output signals from the laser transmitters 110A-110C are carried to an optical wavelength multiplexer (MUX) 112 by the optical fibers 114A-114C. The MUX 112 combines the single-channel inputs from optical fibers 114A-114C into a multi-channel output signal that is carried from the MUX 112 by an output optical fiber 116.

At the receiver unit 104, a demultiplexing unit 120 separates the multi-channel signal into single channel signals that are transported to the optical receivers 124A-124C by the optical fibers 128A-128C.

DWDM communications systems similar to the communications system 100, may operate in different wavelength ranges that are typically selected according to the optical and physical properties of the available transport media in addition to the cost and availability of other system components. For example, the wavelength range between 1.53 μm and 1.63 μm is commonly used for many fiber communications system applications due to the availability of low-loss optical fiber, well-developed erbium fiber amplifiers and long-lived, single-frequency laser transmitters.

In a fiber communications system with channel frequencies assigned according to the ITU convention, a laser transmitter must be stabilized to a fraction of the channel spacing for long periods of time. Lasers incorporating distributed feedback or distributed Bragg reflector structures, for example, may be selected to have a frequency of oscillation that is close to a channel frequency and a frequency stabilization unit may be used to fine tune and lock the laser frequency to the channel frequency.

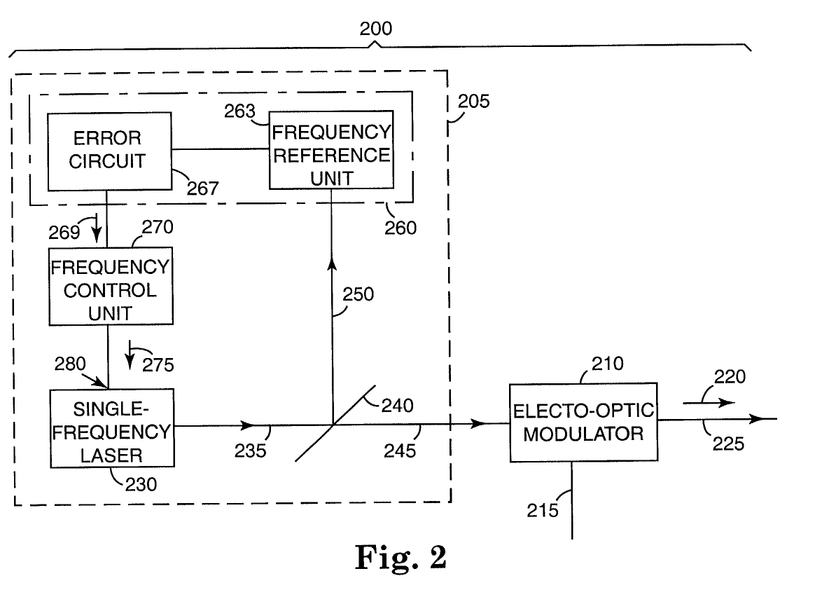

Frequency locking is typically accomplished by interacting a portion of the laser output beam with a frequency reference apparatus to generate an electronic signal with a magnitude that varies in response to the difference between the laser output frequency and a reference frequency. FIG. 2 schematically illustrates a frequency-stabilized optical transmitter 200 comprising a frequency-stabilized laser 205 and an electro-optic modulator 210. Information is encoded on the frequency-stabilized laser output 205 by the electro-optic modulator 210 according to an electronic information signal that is transported to the modulator by the electronic signal cable 215. The modulated optical output 220 from the electro-optic modulator 210 may be carried to an optical transport system by the optical fiber 225.

The frequency stabilized laser source 205 typically includes a single frequency laser 230. For example, the single frequency laser 230 may be a distributed feedback laser or distributed Bragg reflector laser with an unstabilized frequency that is approximately equal to the frequency of an ITU channel in the wavelength range between 1.53 μm and 1.63 μm. The beam splitter 240 typically divides the laser output beam 235 into a reference beam 250 and a frequency stabilized output beam 245. The output beam 245 is directed to interact with the electro-optic modulator 210 and the reference beam 250 is directed to interact with the frequency stabilizer 260.

The frequency stabilizer 260 includes a frequency reference unit 263 and an error circuit 267. The reference unit 263 typically includes a reference optical system with a stable, frequency-dependent optical transfer function and at least one detector to measure the power of the light exiting the optical system. The error circuit 267 typically receives at least one frequency-dependent output signal from the frequency reference unit, generating an error signal 269 that varies with the difference between the frequency of the reference beam 250 and a fixed frequency standard.

The frequency control unit 270 receives the error signal 269 from the frequency stabilizer 260 and generates a laser feedback signal 275 that is received by the laser frequency control port 280. Signals received by the laser frequency control port 280 typically change one or more physical properties of the single-frequency laser 230, thereby changing its output frequency. If the laser 230 is a semiconductor laser, for example, signals received by the laser frequency control 280 port may change the junction current, the temperature of the junction and/or the properties of a passive section of the laser resonator. Alternatively, signals received by the laser frequency control port 280 may directly change the resonator length of the laser 230. The magnitude and phase of the feedback signal 275 are typically adjusted by the frequency control unit 270 to oppose variations in the frequency of the single-frequency laser 230.

The reference optical system within the frequency reference unit 263 conventionally includes two beam paths that interact with separate reference optical subassemblies. The optical subassemblies typically have frequency-dependent transfer functions with different periods and/or different peak frequencies. Suitable reference assemblies may include dielectric spike filters, Fabry-Perot etalons, or other interferometric optics having a periodic frequency-dependent transmission function.

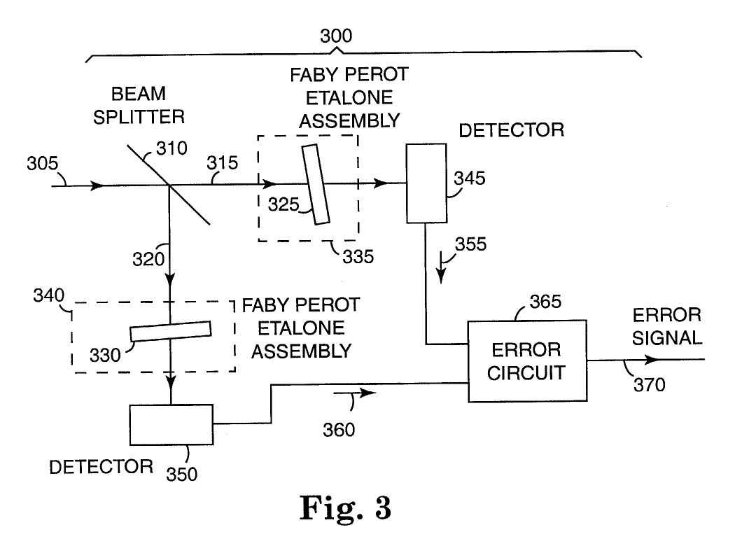

For example, a conventional frequency reference 300 incorporating two Fabry-Perot etalons is illustrated schematically in FIG. 3. The reference beam 305, that may be a portion of the polarized output of a semiconductor diode laser, is typically divided into two, approximately equal portions 315, 320 by the beam splitter 310. The first light beam 315 interacts with the first Fabry Perot etalon 325 and the second light beam 320 interacts with the second Fabry Perot etalon 330.

Fabry-Perot etalons are typically formed from transparent solid materials such as glass and quartz that are cut and optically polished on two parallel surfaces. Dielectric reflective coatings are often applied to the surfaces to increase the surface reflectivity. The frequency-dependent transmission function of a Fabry-Perot etalon has a set of narrow peaks that are separated by a fixed frequency interval. The frequency interval between the transmission peaks varies inversely with the distance between the surfaces, hereafter referred to as the etalon length. The width of the transmission peaks relative to the spacing between the peaks typically with increasing surface reflectivity.

The peak frequencies of a Fabry-Perot transmission curve are sensitive functions of etalon length and the tilt of the etalon surfaces relative to the beam propagation direction. Changes in the surface separation that are small with respect to the wavelength of the reference beam 305 may produce large changes in the peak transmission frequencies. The peak transmission frequencies may therefore be affected by environmental noise that includes temperature variations, vibration and atmospheric pressure changes.

The Fabry Perot etalons 325, 330 have different lengths and different peak transmission frequencies. They are contained in isolation assemblies 335, 340 to minimize thermal and mechanical noise. The power of the light transmitted by the first Fabry Perot etalon 325 is measured by the first detector 345 and the power of the light transmitted by the second Fabry Perot etalon 330 is measured by the second detector 350. The first and second detector output signals 355, 360 are analyzed by the error circuit 365 and an error signal 370, reflecting the difference between the frequency of the reference beam 305 and a fixed frequency standard is generated.

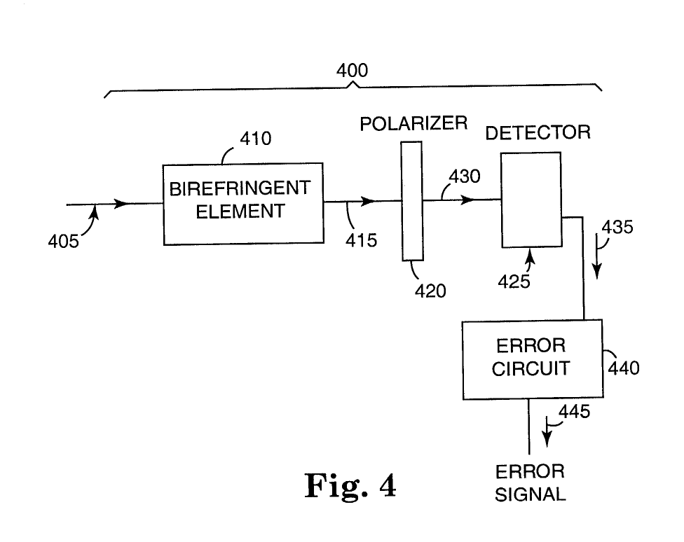

According to the present invention, a fixed frequency standard may be provided by an element having a frequency-dependent birefringence. A birefringent frequency reference unit 400 according to the invention is schematically illustrated in FIG. 4. Polarized light 405 interacts with a birefringent element 410 that has a frequency-dependent birefringence. The polarized light 405 may be generated by a single frequency semiconductor laser that typically produces a polarized output beam. The birefringent element 410 may, for example, be a uniaxial crystal with its optic axis oriented in the plane perpendicular to the propagation direction of the light 405. If the polarization direction of the light 405 is angled at approximately 45° with respect to the optic axis of the birefringent element 410, the light is typically split into two, approximately equal portions that propagate through the crystal at different velocities. The phase of the slower portion is retarded relative to the phase of the faster portion by a phase retardation amount that is a function of the frequency of the light 405.

The polarization state of the light 415 propagating away from the birefringent element 410 is determined by the phase retardation amount imposed by the birefringent element 410. Thus, the polarization state of the light 415 is typically a function of the frequency of the input light 405. A polarizer 420 may be used to analyze the polarization state of the light 415, transmitting, for example, the portion of the light 415 that is polarized in the same direction as the input light 405. The detector 425 measures the power of the transmitted light 430, generating a detector output signal 435 that is typically dependent on the frequency of the light 405. The error circuit 440 may generate an error signal 445 in response to the detector output 435 that typically reflects the difference between the frequency of the polarized light 405 and the reference frequency.

Advantages of the birefringent frequency reference 400 when compared to the Fabry Perot reference 300 include reduced component count, reduced sensitivity to vibration and temperature variation, and improved alignment tolerances. Features of the invention may also facilitate mechanically tuning the frequency dependence of the detector signal 435 and stabilizing the phase retardation of the birefringent element 410 with respect to temperature. The birefringent element 410 may advantageously be formed from a material with a birefringence that is constant over a range of frequencies.

In passing through a length of material with constant birefringence, the phase of light polarized along the slow axis is retarded with respect to the phase of light polarized along the fast axis by an amount proportional to the light frequency. Mathematically,

Δφ=2πf B L

where Δφ is the phase retardation amount, f is the light frequency in Hertz, B the birefringence, and L the length of the material.

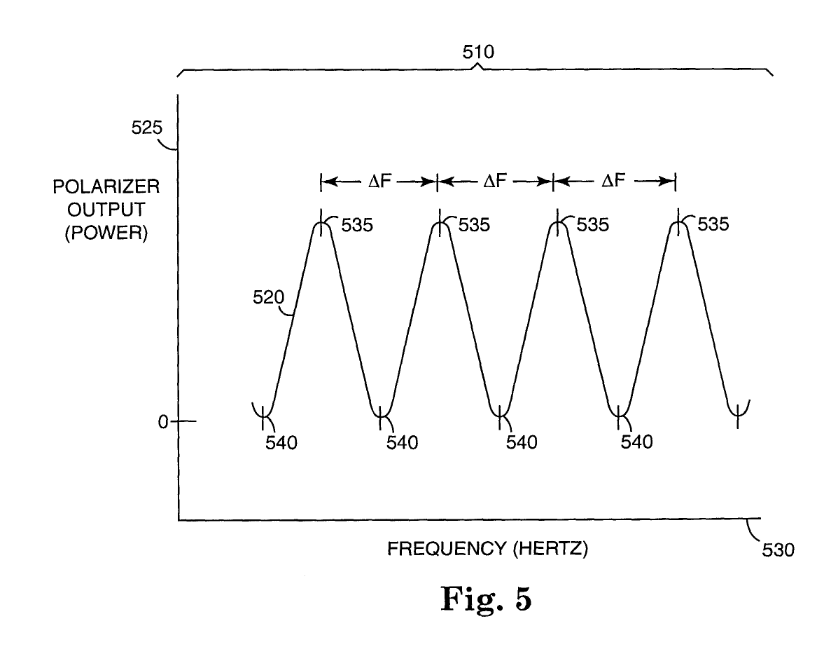

The graph 510 of FIG. 5 shows the approximate power of the polarizer-transmitted light 430 for an element 410 with constant birefringence. The graph 510 assumes the polarization direction of the input light 405 is oriented at approximately 45° relative to the optic axis of the element 410 and the maximum transmission direction of the polarizer 420 is approximately parallel to the polarization direction of the input light 405.

In FIG. 5 the power of the transmitted beam 430 is plotted in arbitrary units along the vertical axis 525 and the light frequency in Hertz is plotted along the horizontal axis 530. The approximately periodic function 520 has maximum values 535 that correspond to retardation amounts that are integral multiples of π and minimum values corresponding to retardation amounts that are odd integer multiples of π/2. The frequency spacing, Δf, between adjacent transmission peaks 535 is approximately constant and inversely proportional to the product of the birefringence and the length of the element.

The birefringent frequency reference 400 has fewer elements than the conventional Fabry-Perot frequency reference 300 and is, therefore, less sensitive to alignment errors. In many applications, such as optical communications, reduced sensitivity to environmental noise and optomechanical simplicity are advantageous.

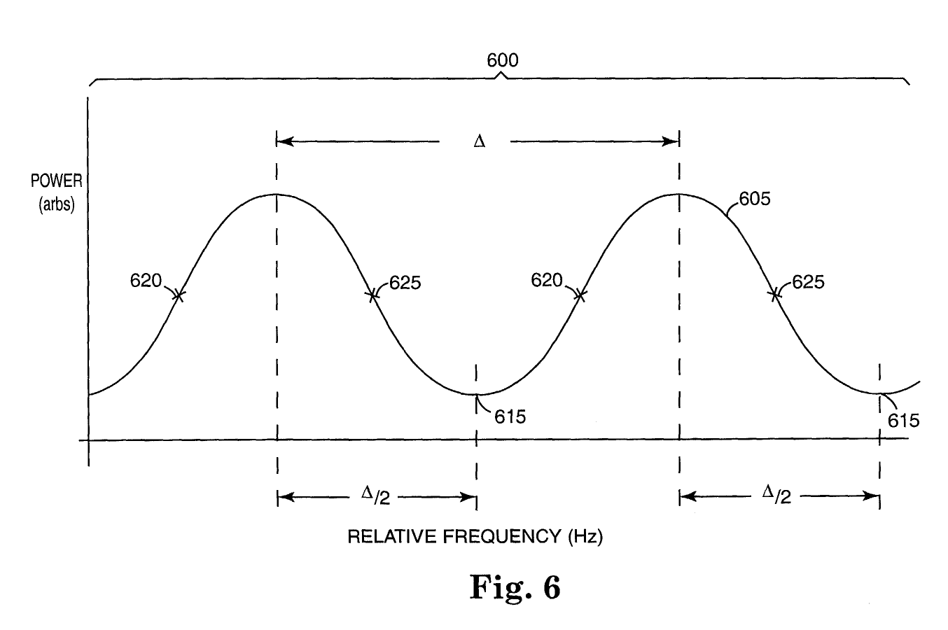

The sensitivity of the frequency reference unit 400 to variations in the frequency of the polarized light 405 is determined by the transmission peak spacing, Δf, and the point on the power transmission curve that corresponds to the standard frequency reference. Typically, it is desirable to adjust crystal length and/or birefringence to maximize the change in transmitted power with frequency at the standard reference frequency. FIG. 6 is a graph 600 showing the power variation of the light 430 as a function of the wavelength of the input light 405. If the birefringence of the element 410 is constant over a range of frequencies, the function 605 will typically have equally spaced transmission peaks 610 over the same frequency range.

Advantageously, the phase retardation of the birefringent element may be adjusted so that an inflection point 620 of the curve 605 corresponds to a reference frequency, mΔ, where m is an integer and Δ is the frequency separation of the transmission peaks. Since the transmission function is typically periodic over a range of frequencies, other inflection points 620 may be located at frequencies that are separated from the reference frequency by integral multiples of Δ. The birefringent frequency reference, 400, can therefore provide frequency stabilization signals for polarized light signals 405 at several frequencies that are spaced by the frequency difference, Δ, over the range of frequencies where the birefringence of the birefringent element 410 is a linear function of the light frequency.

An error signal may also be generated for signals having frequencies that correspond to a second set of inflection points 625. At the points 625, the variation of transmitted power with frequency is opposite in sign to the variation at the inflection points 620.

Over the frequency range where the birefringence of the element 410 is constant, the frequency reference unit 400 may be used to generate frequency error signals for a plurality of the channels of a DWDM system. For example, the length and/or the birefringence of the element 410 may be selected so the frequency spacing, Δ, between adjacent peaks in the transmission curve 605 is approximately equal to the channel spacing of an ITU standard DWDM signal, for example, 100 GHz. Alternatively, a frequency reference with the transmission curve 605 may provide a frequency error signal for the odd and even channels of a DWDM signal with a frequency spacing between odd and even channels of 50 GHz. In this case, the even channels may have frequencies corresponding to the inflection points 620 while the odd channels may have frequencies corresponding to the inflection points 625.

In frequency reference application, the inflection points 620, 625 may be tuned to specific frequencies by changing the birefringence or the length of the birefringent element 410. If the element is formed from a single material segment, the length/birefringence product may be changed by heating or stressing the element.

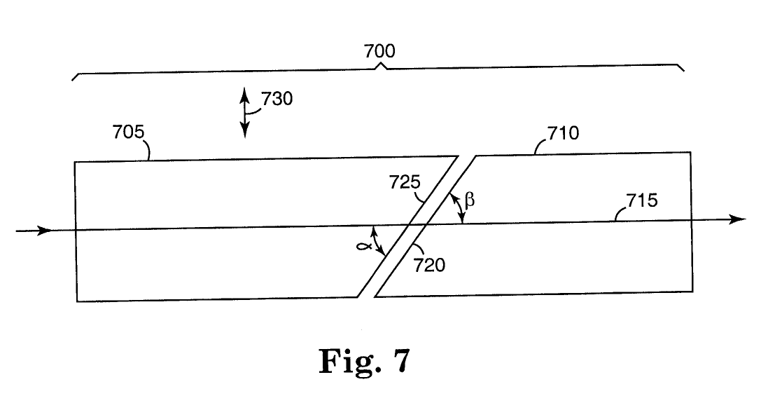

Alternatively, a birefringent element 700 as shown schematically in FIG. 7 may be formed from two segments of birefringent material 705, 710. Light propagates through the element 700 along the axis 715 and typically interacts with both segments. The interior surfaces 720,725 of the segments 705,710 are typically oriented at acute angles, α, β. The phase retardation amount of the birefringent element 700 may be tuned by translating the segment 705 with respect to the segment 710 in the direction indicated by the arrow 730. This translation changes the distance over which light propagating along the axis 715 interacts with the segment 705.

The segments 705, 710 may be formed from the same or different materials. For example, the effect of temperature variations on the phase retardation amount provided by the element 700 may be minimized by forming the segment 705 from a material with a birefringence that changes with temperature according to a first temperature coefficient. The segment 710 may be formed from a material with a birefringence that changes with temperature according to a second temperature coefficient of birefringence that is opposite in sign to the first temperature coefficient. In this way the temperature changes in birefringence of the first segment may offset the temperature change in birefringence of the second segment, thereby temperature compensating the element 700. The tuning of the phase retardation amount of a birefringent element with a plurality of segments is discussed in the U.S. patent application entitled “Method and apparatus for adjusting an optical element to achieve a precise length”, U.S. patent application Ser. No. 09/694,691, which is hereby incorporated into this application by reference. The thermal compensation of the phase retardation of a birefringent element with a plurality of segments is discussed in the U.S. patent application “Method and apparatus for thermally compensating a birefringent optical element”, U.S. patent application Ser. No. 09/694,148, which is hereby incorporated into this application by reference.

Typically, the output power of a laser is also a sensitive function of junction current, temperature and/or device age. In the birefringent laser frequency stabilizer, 400, the optical power of the light 430 may change with both the frequency of the input light 405 and the power of the input light 405. In some cases, it may be desirable to eliminate the effect of power variations on the error signal 445.

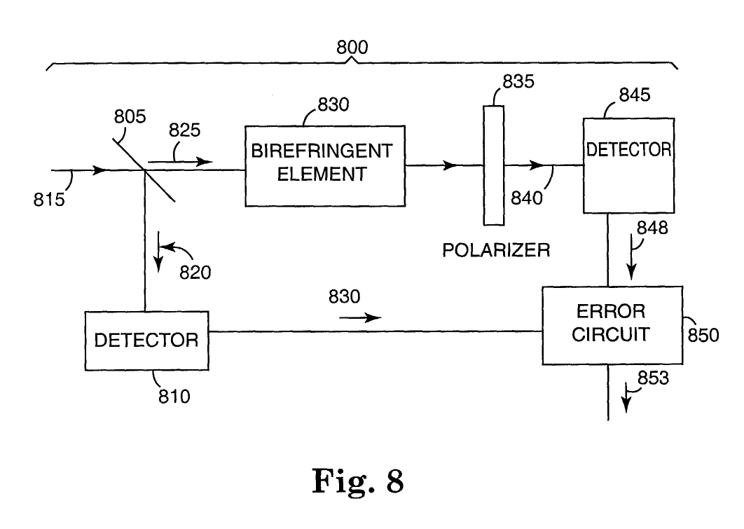

A power-corrected birefringent frequency stabilization unit 800 is schematically illustrated in FIG. 8. Power correction is accomplished by including a beam splitter 805 and a detector 810 for monitoring the laser power. Input light 815 from a single-frequency semiconductor laser, for example, is divided by the beamsplitter 805 into a power measurement beam 820 and a frequency measurement beam 825. The frequency measurement beam interacts with a uniaxial birefringent element 830 and is transmitted by the polarizer 835. The input light 815 is typically polarized and the optic axis of the birefringent material typically lies in a plane orthogonal to the propagation direction of the frequency measurement beam 825. If the polarization direction of the beam 825 is angled at approximately 45° to the optic axis of the birefringent element 830 and the birefringence of the element 830 is a function of frequency, the power of the light 840 transmitted by the polarizer 835 reflects the difference between the frequency of the light 815 and a standard reference frequency.

The detector 845 generates a signal 848 that is related to the power of the light 840 and the detector 810 generates a signal 830 that is related to the power of the light in the power measurement beam 820. The error circuit 850 receives the signals 830, 848 and generates a power-corrected error signal 853 in response to the signal 830, 848. The error circuit may, for example, calculate the ratio of the power measured by the detector 845 to the power measured by the detector 810.

A power measurement signal may alternatively be obtained by measuring the leakage of light from a laser thereby eliminating the beamsplitter 805. For example, the power of the light leaking from the non-output facet of a semiconductor laser is proportional to the output power and may be used as a power measurement signal.

As noted above, the present invention is applicable to the frequency stabilization of light sources and is particularly useful in providing a frequency stabilization system for single frequency laser transmitters in fiber optic communications systems. Accordingly, the present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. A light frequency stabilization unit, comprising:
a birefringent element having a longitudinal axis, the birefringent element having an optical axis oriented to retard phase of polarized light propagating through the element substantially parallel to the longitudinal axis by a phase retardation amount proportional to a frequency of the polarized light;
a polarizer disposed to receive phase-retarded light from the birefringent element, the polarizer transmitting a portion of the phase-retarded light, a magnitude of the transmitted portion being determined by the phase retardation amount;
a first optical detector disposed to detect the transmitted portion of light, the first optical detector generating a first signal in response to the transmitted portion detected; and
an electronic error circuit coupled to the detector, the electronic error circuit generating a frequency stabilization signal in response to the first signal.

2. A frequency stabilization unit as recited in claim 1 wherein the birefringent element is formed of a single birefringent material segment.

3. A frequency stabilization unit as recited in claim 1, wherein the birefringent element includes a plurality of birefringent material segments disposed along the longitudinal axis, the phase retardation amount being responsive to the position of at least one of the birefringent material segments relative to the longitudinal axis.

4. A frequency stabilization unit as recited in claim 1, wherein the birefringent element includes a plurality of birefringent material segments disposed along the longitudinal axis, thermal variation in a phase retardation amount provided by at least one of the pieces substantially compensating thermal variation in a phase retardation amount provided by at least another one of the pieces.

5. A frequency stabilization unit as recited in claim 1, wherein the birefringent element has an optic axis direction oriented at an angle of approximately 45° with respect to a polarization direction of the input polarized light.

6. A frequency stabilization unit as recited in claim 1, wherein the polarizer is oriented with a direction for maximum transmission angled at approximately 45° from the optic axis of the birefringent element.

7. A frequency stabilization unit as recited in claim 1, wherein the polarized light includes a plurality of frequency-distinct signals, the phase retardation amount experienced by a first signal differing from the phase retardation amount experienced by at least a second signal by an integer multiple of π.

8. A frequency stabilization unit as recited in claim 1 wherein the polarized light includes odd channels and even channels, the phase retardation amount experienced by the odd channels differing from the phase retardation amount experienced by the even channels by an odd integer multiple of π/2.

9. A frequency stabilization unit as recited in claim 1 wherein the phase retardation amount is approximately a periodic function.

10. A frequency stabilization unit as recited in claim 1 further comprising a second detector and a beam splitter, the beam splitter disposed to direct a portion of the input polarized light to the second detector, the second detector generating a second signal that is substantially independent of the frequency of the polarized light and indicative of optical power of the polarized light.

11. The frequency stabilization unit as recited in claim 10, the error circuit additionally coupled to receive the second signal, and generate a light frequency stabilization signal in response to the first signal and the second signal.

12. A frequency-stabilized laser source comprising,
a laser with a frequency-control port, an operating frequency of the laser being variable in response to a frequency control signal applied to the frequency control port;
a birefringent element having a longitudinal axis, the birefringent element having an optical axis oriented to retard phase of polarized light propagating through the element substantially parallel to the longitudinal axis by a phase retardation amount proportional to a frequency of the polarized light;
a polarizer disposed to receive phase-retarded light from the birefringent element, the polarizer transmitting a portion of the phase-retarded light, a magnitude of the transmitted portion being determined by the phase retardation amount;
a first optical detector disposed to detect the transmitted portion of light, the first optical detector generating a first signal in response to the transmitted portion detected; and
a feedback circuit disposed to receive the first signal and provide the frequency control signal to the laser frequency control port.

13. A frequency-stabilized laser as recited in claim 12, wherein the birefringent element has an optic axis direction oriented at an angle of approximately 45° with respect to a polarization direction of the polarized light received from the laser.

14. A frequency stabilized laser as recited in claim 12, further comprising a second detector and a beam splitter, the beam splitter disposed to direct a portion of the polarized light from the laser to the second detector to produce a second detector output signal indicative of polarized light power from the laser, the feedback circuit being coupled to receive the first signal and the second signal and to generate the frequency control signal in response to the first signal and the second signal.

15. A frequency stabilized laser as recited in claim 12, wherein the birefringent element includes at least two birefringent material segments, the phase retardation amount being responsive to the translation of at least one of the birefringent material segments relative to the longitudinal axis.

16. A frequency stabilized laser as recited in claim 12, wherein the birefringent element includes a plurality of birefringent material segments disposed along the longitudinal axis, thermal variation in the phase retardation amount provided by one of the pieces substantially compensating thermal variation in phase retardation amount provided by at least another one of the pieces.

17. A frequency stabilized laser as recited in claim 12, wherein the polarizer is oriented with a direction for maximum transmission angled at approximately 45° from the optic axis of the birefringent element.

18. A frequency stabilized laser as recited in claim 12, wherein the feedback signal is approximately a periodic function of frequency of the laser.

19. An optical communications system, comprising:
a transmitting unit including a light frequency stabilization unit disposed to stabilize frequency of at least one optical signal, the frequency stabilization unit including
i) a birefringent element having a longitudinal axis, the birefringent element having an optical axis oriented to retard phase of polarized light propagating through the element substantially parallel to the longitudinal axis by a phase retardation amount proportional to a frequency of the polarized light,
ii) a polarizer disposed to receive phase-retarded light from the birefringent element, the polarizer transmitting a portion of the phase-retarded light, a magnitude of the transmitted portion being determined by the phase retardation amount,
iii) a first optical detector disposed to detect the transmitted portion of light, the first optical detector generating a first signal in response to the transmitted portion detected, and
iv) an electronic error circuit that generates a frequency stabilization signal in response to the first signal;
a receiving unit;
and an optical transport system coupled to carry optical signals from the transmitting unit to the receiving unit.

20. An optical communications system as recited in claim 19, wherein the at least one optical signal includes a plurality of frequency-distinct signals, a phase retardation amount experienced by a first signal differing from a phase retardation amount experienced by at least a second signal by an integer multiple of π.

21. An optical communications system as recited in claim 19 wherein the at least one signal includes odd channels and even channels, the phase retardation amount experienced by the odd channels differing from the phase retardation amount experienced by the even channels by an odd integer multiple of π/2.

22. An optical communication system as recited in claim 19, wherein at least one of the receiver unit and transmitter unit is part of a transceiver unit.

23. A method for generating a light frequency stabilization signal, comprising:
retarding polarized light, using a birefringent element, by an amount that is proportional to a frequency of the polarized light;
analyzing the phase-retarded light with a polarization analyzer to produce an analyzed light beam;
measuring power of the analyzed light beam with a first detector to generate a first signal indicative of light frequency;
generating the light frequency stabilization signal in response to the first signal.

24. A method as recited in claim 23 further comprising:
directing a portion of the polarized light to a second detector to generate a second signal indicative of light power; and
producing a power-corrected light frequency stabilization signal using the first and second signals.

25. A method as recited in claim 23 including compensating thermal path length effects in the birefringent element.

26. A method for generating a light frequency stabilization signal as recited in claim 23 including setting a phase retardation of the birefringent element by providing the birefringent element as at least two segments, each element having non-parallel faces and translating at least one of the at least two segments across the polarized light.

27. A method for stabilizing the frequency of a laser, comprising:
retarding phase of polarized light, generated by the laser, by an amount that is proportional to a light frequency;
analyzing the phase-retarded light with a polarizer to produce an analyzed light beam;
measuring power of the analyzed light beam with a first detector to generate a first signal indicative of laser frequency
generating a laser feedback signal in response to the first signal;
and adjusting frequency of the laser according to the feedback signal so as to stabilize the frequency of the laser.

28. A method as recited in claim 27 further comprising directing a portion of the light from the laser to a second detector to generate a second indicative of laser power, and wherein generating the laser feedback signal includes generating the laser feedback signal in response to the second signal.
